(19) United States
(12) Patent Application Publication
(10) Pub. No.: US 2010/0019062 A1
(43) Pub. Date: Jan. 28, 2010

(54) TANK SPRAYER WITH SEPARATE CONCENTRATE CONTAINER

(75) Inventor: Michael T. Clarke, Grand Rapids, MI (US)

Correspondence Address: Waters & Associates, 161 Ottawa Ave., N.W., 305B WATERS BUILDING, Grand Rapids, MI, 49503, US

(73) Assignee: Root-Lowell Manufacturing Company, Lowell, MI (US)

(21) Appl. No.: 12/178,093

(22) Filed: Jul. 23, 2008

(51) Int. Cl. B67D 7/78; B67D 5/60

(52) U.S. Cl. 239/373; 222/145.1

(57) ABSTRACT

A manually pressurizable house and garden tank sprayer employing a separate diluent tank and liquid chemical concentrate container, wherein the concentrate container is mounted to and carried by the diluent container or by a spray wand. The tank containing diluent is pressurized by a conventional hand pump, and the same hand pump pressure pressurizes the concentrate container. The diluent and concentrate chemical are not admixed until just before the liquids are dispensed, so that unused chemicals are not contaminated or diluted until they are used.

### CROSS-REFERENCE TO RELATED APPLICATIONS

Not Applicable.

### STATEMENT REGARDING FEDERALLY SPONSORED RESEARCH OR DEVELOPMENT

Not Applicable.

### PARTIES TO A JOINT RESEARCH AGREEMENT

Not Applicable.

### REFERENCE TO A SEQUENCE LISTING

Not Applicable.

### BACKGROUND OF THE INVENTION

The present invention relates to a tank sprayer having a separate concentrate container that is carried by the tank or by the chemical dispenser.

A typical tank sprayer for home and garden use is a liquid chemical dispenser device for dispensing a mixture of a liquid chemical and diluent. A tank sprayer typically includes a liquid container or tank pressurized by a hand pump integrated into a removable top or closure for the container. Liquid in the tank is dispensed by the pressure in the tank through a hose or tube that leads to a nozzle on a spray wand, which is operated by a trigger valve. To use a tank sprayer, liquid from a concentrate container is usually poured into the tank and mixed with water (or other diluent) in the tank. The tank is then closed and pressurized with the pump incorporated in the tank top, and liquid is sprayed with the spray wand. When the spraying is done, the remaining portion of liquid in the tank is often either discarded or stored in the tank or some other container, creating a question regarding the strength and identity of the mixture at a later date because the tank is not labeled with the manufacturer's product. In systems where a concentrate can be housed in a separate container so it is not mixed with a diluent, it can be cumbersome to transport the diluent tank along with a separate concentrate container.

An object of the present invention is to provide an improved tank sprayer having a pressurizable tank for housing water or other diluent and a separate pressurizable liquid container for housing the liquid chemical, with the sprayer discharging both liquids by positive pressure from the tank and preventing admixture of the liquids until just before they are discharged. A further object of the invention is to provide an attachment mechanism whereby the separate concentrate container can be conveniently clipped into a recess in the side of the diluent tank or screwed into a connector incorporated into the dispensing wand, and the spray wand can be clipped into the tank for carrying, making the invention less cumbersome and more convenient to transport and use.

### SUMMARY OF THE INVENTION

The present invention comprises a tank sprayer comprising a diluent container, concentrate container, hand pump assembly, dispensing assembly, and hose connections.

The hand pump assembly enables the user to pressurize the diluent tank with pressurized air, thereby forcing the diluent under positive pressure from the tank. The diluent travels through a hose or tube into the dispensing wand, where it is mixed with concentrate from a separate container before being expelled from a spray nozzle. The pressurized air in the tank also pressurizes the concentrate container by means of a hose or tube that provides pressure communication between the two containers. The air pressure provided from the tank forces the concentrate out of its container and into the dispensing wand, where it mixes with the diluent before being expelled from the spray nozzle. In one embodiment, the concentrate container is held in place by being resiliently clipped into a recess in the side of the container. In another embodiment, the concentrate container is mounted to the wand. In both cases, the concentrate is not mixed with diluent until the diluent leaves the tank.

Because the concentrate is housed separately from the diluent even during use, the user does not have to fumble with mixing the liquids, where spills are common. In addition, when spraying is complete, the concentrate container may simply be removed from the tank and the original cap for the concentrate bottle can be reattached for storage; the diluent tank can simply be emptied. In addition, because the concentrate container can either be conveniently housed in a recess in the wall of the diluent tank or attached to the dispensing assembly, the entire system can more easily be handled and transported by the user.

These and other features, objectives, and benefits of the invention will be recognized by one having ordinary skill in the art and by those who practice the invention, from this disclosure, including the specification, the claims, and the drawing figures.

### BRIEF DESCRIPTION OF THE DRAWINGS

FIG. 1 is a side elevational view of a first embodiment of the present invention showing a liquid chemical dispenser bottle connected to the handle of the sprayer outlet wand.

FIG. 2 is a side elevational view of a second embodiment of the present invention showing a liquid chemical container clipped in a recess in the side of the sprayer tank.

### DETAILED DESCRIPTION OF PREFERRED EMBODIMENT

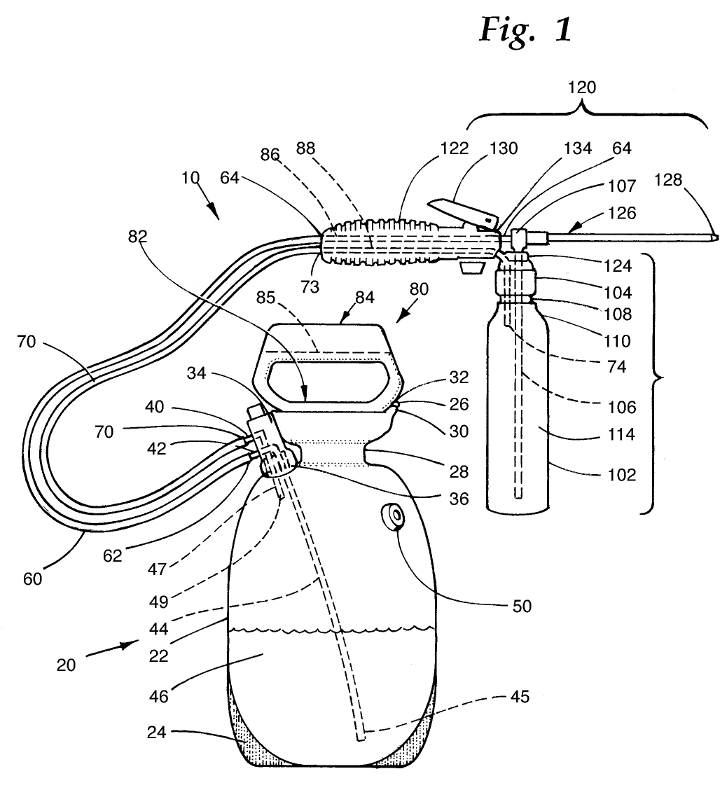

In accordance with the present invention, a first embodiment of a tank sprayer 10 (hereinafter “sprayer”) having a separate liquid chemical container or concentrate container is shown in FIG. 1. Sprayer 10 comprises a diluent container or tank assembly 20, liquid delivery hose or tube 60, pressure hose or tube 70, hand pump assembly 80, concentrate or liquid chemical container assembly 100, and liquid dispensing assembly 120.

In the embodiment illustrated in FIG. 1, the tank or diluent container assembly comprises a hollow, one-piece, molded tank 22 having an elliptical sidewall configuration and a plurality of spaced protrusions 24 on the bottom of the tank that serve as supporting surfaces or feet for the tank. A mouth or inlet 26 is formed at the top of the tank and includes a neck 28 and lip 30 surrounding an inlet passage 32 into the open interior of the hollow tank. A tank outlet fitting 34 is sealingly mounted on an outlet opening 36 in the outer wall of the tank at an upper position on the tank. The tank outlet fitting includes a pressure outlet fitting 40 and a liquid outlet fitting 42. An internal diluent outlet tube 44 extends downward from the liquid outlet fitting 42 inside the tank to end 45 adjacent the bottom of the tank, permitting the delivery of diluent 46 from the tank when the tank is pressurized.

An external liquid delivery tube 60 for diluent is connected at one end 62 to liquid outlet fitting 42 outside the tank and terminates at the dispensing assembly 120 at an opposite end 64. The dispensing assembly comprises a spray wand 126 having a handle 122 at one end and a spray nozzle 128 at the other end. Diluent from the tank travels through the liquid delivery tube 60, through end 64, and into the dispensing wand 126 through tube 86 in handle 122. The diluent is thereafter dispensed through nozzle 128 at the end of the wand. Trigger assembly 130 in the handle controls liquid flow through the wand.

A pressure tube 70 is connected at one end 72 to pressure outlet fitting 40 at the outer side of the tank and is connected at the other end 73 to tube 88 extending through handle 122. Tube 88 extends through cap 104 and terminates at end 74 within a concentrate container 102. A pressure tube 47 extends into the tank from fitting 42 to an end 49 at an upper portion of the tank for conveying pressurized gas from the tank to pressure tube 70.

Hand pump assembly 80 provides a sealed cover for tank inlet 26 and comprises a conventional hand pump 82 that extends into the tank from a pump handle 84. The handle includes a recess or groove 85 in the upper side in which the handle 122 of the spray wand can be clipped for releasibly fastening the wand to the tank for carrying the wand along with the tank. Vertical reciprocation of the pump handle after removal of the wand therefrom pressurizes the tank. This forces the diluent under positive pressure from the diluent outlet tube, through the liquid delivery tube 60, ultimately to be expelled from spray nozzle 128.

The air pressure that is created in the tank by the hand pump is also transferred to the concentrate container 102 via the pressure tube 70, where it pressurizes the concentrate container.

The concentrate container assembly 100 comprises concentrate container 102, a sealable concentrate container cap 104, and a concentrate outlet tube 106. An externally threaded mouth 108 on an open top 110 of the concentrate container allows the concentrate container to be releasably connected to the internally threaded concentrate container cap 104. Pressurized air generated in the tank 22 by the hand pump is transferred via pressure tube 70, through the dispenser handle, and into the concentrate container, urging concentrate 114 to travel under positive pressure through the concentrate outlet tube 106 to junction 107 where the concentrate and diluent are mixed, just before the concentrate and diluent are dispensed from the wand.

Dispensing assembly 120 includes a concentrate bottle connector 124 at the end of handle 122. Concentrate container cap 104 is incorporated in connector 124. With this embodiment, the concentrate bottle is carried by the spray wand handle as a component of the dispensing assembly, with the liquid concentrate chemical and the diluent (water generally) being admixed just before they are dispensed, so there is no problem with the disposal of mixed chemicals that are not used.

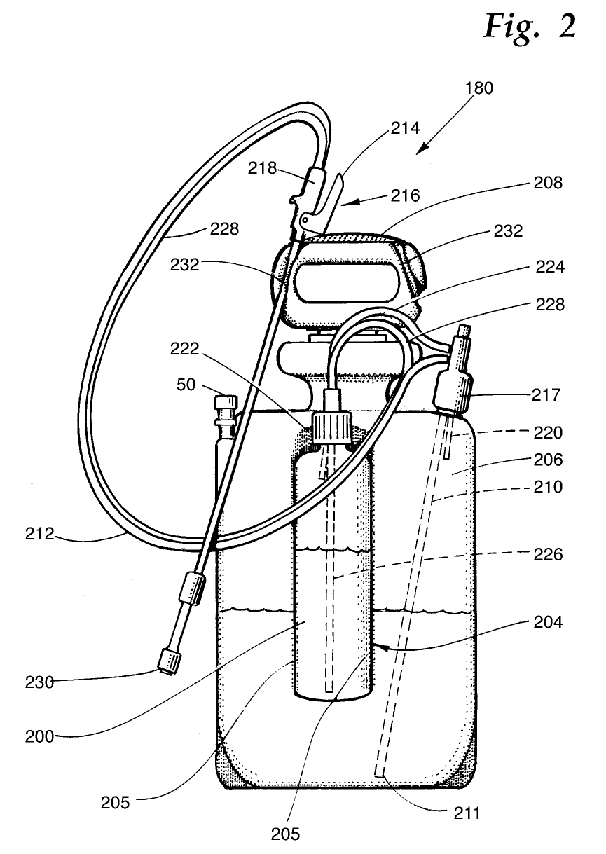

In a second embodiment 180 of the present invention, shown in FIG. 2, concentrate container 200 fits snugly within an arcuate seat or recess 204 in the outer wall of diluent tank 206. Desirably, recess 204 is shaped to extend around more than half of the circumference of the concentrate bottle, with spaced outer edges 205 being separated apart by a distance less than the diameter of the bottle, so the bottle will lodge in the recess and be restricted from falling out through the open side in the recess. The open side, however, will enable the user to see how much concentrate remains in the bottle if a translucent or transparent bottle or bottle panel is employed.

In this embodiment, the tank is also pressurized by a hand pump 208, forcing diluent from the tank under positive pressure through a liquid diluent outlet tube 210 that extends from an inlet 211 adjacent the bottom of the tank, through tank outlet fitting 217 to delivery tube 212 outside the tank. The liquid diluent then flows to spray wand 216, where it mixes with concentrate at a junction in the handle 218 of the spray wand. The liquids are mixed inside the wand handle before being expelled from the spray nozzle 230 by trigger valve 214.

The pressure created by the hand pump is transferred from the pressure tank though internal pressure tube 220, through outlet fitting 217, and then through pressure tube 224, through the concentrate container cap 222, and into the concentrate container 200. There, the pressure forces the concentrate into the concentrate outlet tube 226, through cap 222, and then into the concentrate delivery tube 228, which extends into the dispensing wand. The concentrate then mixes with the diluent at a junction in the wand before being expelled with the diluent from the spray nozzle 230. In particular, while the junction of the concentrate and diluent delivery tubes desirably is as close to the spray nozzle as possible, in order to minimize admixture of liquids that may not be dispensed, the junction can be positioned elsewhere, as long as the liquids are mixed after they leave their storage containers. A conventional pressure relief valve 50 in the tank walls of both embodiments prevents excessive pressure from building within the pressure tank and concentrate container. The spray wand clips resiliently within either of two recesses 232 in the side of the handle for carrying the spray wand with the tank.

The foregoing is merely exemplary of the preferred practice of the present invention, and various changes and modifications may be made in the arrangements and details of construction of the embodiments disclosed herein without departing from the spirit and scope of the present invention.

1. A tank sprayer with separate concentrate container carried by the sprayer, comprising:
a pressurizable diluent container having an open interior and an inlet with a removable cover, the diluent container including a pump for pressurizing the interior of the container with gas pressure, the diluent container having a liquid outlet for discharging diluent, the liquid outlet being in fluid communication with the interior of the tank at a position adjacent a lower portion of the tank, such that gas pressure in the tank forces liquid in the tank out of the liquid outlet;
a separate pressurizable liquid concentrate container for holding liquid chemical concentrate that is to be admixed with the diluent before being applied to lawn or garden vegetation or other target material, the concentrate container having an open interior and an open top that is closed by a removable cap, the interior of the concentrate container being pressurizable when the top is closed, the concentrate container having a gas inlet for pressurized gas and a liquid outlet for pressurized liquid concentrate, the liquid outlet being in communication with the interior of the concentrate container at a position adjacent a bottom thereof such that gas pressure applied to the interior of the concentrate container through the gas inlet urges liquid concentrate to flow out of the concentrate container through the liquid outlet when the top is closed;
a liquid dispenser comprising a spray wand for spraying liquid from the diluent container and concentrate container, the wand being actuated by a manually actuable shutoff valve, the wand having an inlet that is connected to the diluent container liquid outlet by a flexible delivery tube;
attachment means for releasibly mounting the liquid concentrate container on one of the diluent container and the liquid dispenser, such that the liquid concentrate container is carried by the diluent container or the liquid dispenser;
a gas pressure tube interconnecting the diluent container with the concentrate container, the pressure tube having an inlet in communication with pressurized gas in the interior of the diluent container and having an outlet in communication with the interior of the liquid concentrate container, such that gas pressure in the diluent container is transmitted through said tube to the concentrate container so as to pressurize the interior of the concentrate container when the top of the concentrate container is closed and the diluent container is pressurized;
a diluent conduit for conveying pressurized liquid diluent from the diluent container liquid outlet to a liquid inlet on the spray wand;
a concentrate conduit for conveying pressurized liquid concentrate from the liquid concentrate container outlet to the spray wand separately from the diluent, the concentrate conduit having an outlet in fluid communication with the liquid diluent such that the spray wand nozzle discharges a combination of liquid concentrate and liquid diluent at the spray nozzle, and such that the liquid diluent and liquid concentrate are admixed before discharge from the spray nozzle but are not admixed in the diluent container or concentrate container, preventing contamination of the liquid in the concentrate container with liquid from the diluent container, the concentrate and diluent being dispensed by pressure received from the diluent tank pump, the single pump reducing cost and facilitating dispensation while ensuring that there is a continuous relationship between the pump pressure that causes liquid dispensation from both containers.

2. A tank sprayer as in claim 1 wherein the diluent container includes a recess in the side thereof that resiliently engages and holds the concentrate container therein, such that the concentrate container can be carried by the diluent container.

3. A tank sprayer as in claim 2 wherein the recess is shaped to fit partially around the concentrate container, with the diluent container having spaced apart outer side edges that render the side of the concentrate container visible when the concentrate container is mounted in the diluent container.

4. A tank sprayer as in claim 1 wherein the concentrate container is releasibly mounted on the liquid dispenser.

5. A tank sprayer as in claim 4 wherein the concentrate container is mounted on the liquid dispenser by means of a releasible fastener on a cap connected to a handle of the liquid dispenser, the cup releasibly engaging and closing the open top of the concentrate container such that the concentrate container is pressurized when the diluent tank is pressurized.

6. A lawn and garden tank sprayer with separate concentrate container comprising:
a diluent tank comprising a pressurizable container having an open interior and a closeable top, the tank including a manually operable air pump to pressurize the interior of the tank, the tank including a liquid outlet for discharging liquid diluent from the tank in response to pressure in the tank, the liquid outlet being in communication with a lower portion of the interior of the tank, the tank further including a gas outlet for conveying pressurized air from the tank, the gas outlet being in communication with an upper portion of the interior of the tank;
a separate, pressurizable concentrate container for dispensing concentrate liquid, the concentrate container having an open interior and a closeable top, the top having a gas inlet for conveying pressurized gas to the interior of the concentrate container, the top further having a liquid outlet in communication with a lower portion of the interior of the concentrate container for conveying liquid concentrate from the concentrate container in response to pressure in the container;
a manually operable liquid dispenser comprising a spray wand having a handle with a manually operable actuator and having an outlet nozzle at an outer end, the handle having separate inlets for diluent liquid and concentrate liquid, the inlets merging in a junction in the dispenser so as to blend the liquids before the liquids are discharged from the nozzle, such that the liquids remain separate and reusable until just before they are discharged from the nozzle;
a gas pressure tube connected between the diluent tank gas outlet and the concentrate container gas inlet so as to pressurize the concentrate container with pressurized gas from the diluent container;
a liquid tube connected between the diluent tank liquid outlet and the diluent liquid inlet of the liquid dispenser;
a liquid tube connected between the concentrate container liquid outlet and the concentrate liquid inlet of the liquid dispenser; and
a concentrate container mounting mechanism incorporated into one of the diluent tank and dispenser, the concentrate container being mounted on the diluent tank or dispenser by the mounting mechanism, such that the concentrate container is automatically transported with the diluent container or dispenser.

7. A lawn and garden tank sprayer as in claim 6 wherein the concentrate container comprises a bottle having a diameter substantially smaller than a diameter of the diluent container, the mounting mechanism comprising an integral recess in the diluent container in which the concentrate container bottle fits, so as to be carried with the diluent container.

8. A lawn and garden tank sprayer as in claim 7 wherein the recess comprises an indentation formed in the side of the diluent container, the indentation having opposed outer edges that are spaced apart by less than a diameter of the concentrate bottle, the concentrate bottle fitting into the indentation, a side of the bottle being translucent and being visible through the spaced outer edges of the indentation, such that the amount of liquid concentrate remaining in the concentrate container is visible through the side of the bottle when the bottle is mounted in the indentation.

9. A lawn and garden sprayer as in claim 1 wherein a cap for closing the open top of the concentrate container is mounted in the spray wand, the cap having a releasable and sealable fastener thereon that fits on and holds the open top of the concentrate container, such that, when attached to the dispenser, the concentrate container is carried by the dispenser.
